(19) United States
(12) Patent Application Publication
(10) Pub. No.: US 2012/0309661 A1
(43) Pub. Date: Dec. 6, 2012

(54) LOW-VOC SOLVENT SYSTEMS

(76) Inventors: Jörg Adams, Bad Neuenahr (DE); Fabrice Valchera, Hanau (DE)

(21) Appl. No.: 13/574,466

(22) PCT Filed: Jan. 21, 2011
(86) PCT No.: PCT/EP11/50865

§ 371 Date: Jul. 20, 2012

(30) Foreign Application Priority Data
Jan. 21, 2010 (US) 61296946

(51) Int. Cl. C11D 7/50; C09K 3/00; C11D 3/60; C09D 11/02

(52) U.S. Cl. 510/174; 106/31.13; 252/364; 510/405

(57) ABSTRACT

The invention relates to environmentally friendly, multi-purpose, cost-effective compositions based on one or more special solvent that comprise only very small amounts of VOCs. The compositions are preferably one-system compositions. In preferred embodiments of the invention the compositions are even free of VOCs. Because of their low flammability or even non-flammability as well as their low VOC content the compositions guarantee higher workplace safety, reduced insurance costs and reduced costs due to environmental legislation.

The invention relates to environmentally friendly, multi-purpose, cost-effective compositions based on one or more special solvent that comprise only very small amounts of VOCs. The compositions are preferably one-system compositions. In preferred embodiments of the invention the compositions are even free of VOCs.

Because of their low flammability or even non-flammability as well as their low VOC content the compositions guarantee higher workplace safety, reduced insurance costs and reduced costs due to environmental legislation.

VOCs are “volatile organic compounds” which, according to EC Directive 1999/13/EC (Solvent Emissions Directive), have vapor pressures higher than 0.01 kPa at standard room temperature (293.15 K). There are many definitions of VOCs in the literature. In the present invention the aforementioned one is applied.

However, VOCs can also be defined otherwise. For example, Health Canada classes VOCs as organic compounds that have boiling points roughly in the range of 50 to 250° C. (122 to 482° F.). The emphasis is placed on commonly encountered VOCs which would have an effect on air quality. The United States Enviromental Protection Agency regulates VOC in the air, water, and land.

Because of their volatility and their solubility characteristics VOCs are presently used in lots of industrial applications, e.g. as solvent components in printing inks, paint thinners and dry-cleaning agents. However most of these substances are harmful or even toxic and, because of their widespread use, are common ground-water contaminants. Therefore, it is desirable to reduce their presence in industrial processes.

A wide range of solvents are typically used in cleaning solutions for various printing operations as well as in printing inks. Typically, the press cleaning compositions for offset printing contain petroleum-based solvents such as naphtha, mineral spirits and hydrocarbons, which are generally mixtures of materials of differing molecular weights, and are classified by boiling points rather than chemical structures. Further oxygenated solvents such as alcohols, glycol ethers, esters and ketones are also commonly used. Oxygenated solvents are those having hydroxyl or carbonyl groups which are more polar than the relatively non-polar hydrocarbon solvents. These chemicals contain oxygen in the molecule, and have greater solvency for most resin types used in coatings.

Typical cleaning compositions for narrow web printing processes (e.g. offset printing, screen printing, flexographic, letterpress) contain ether alcohols, such as hexylene glycol, butyl glycol, butyl diglycol, dipropylene glycol monoethyl ether, methoxypropanol, dipropylene glycol monomethyl ether, Solvenon® PM, Dowanol® PM; alcohols, such as glycerin, 2-ethyl hexanol, ethanol; ketones, such as acetone; esters, such as methoxypropyl acetate, ethyl acetate, n-butyl acetate; aliphatic hydrocarbons, such as cyclohexane; aromatic hydrocarbons, such as toluol, xylol, solvent naphtha; and hydro-aromatic hydrocarbons, such as Exxol® D60, Exxol® D100.

Such solvents often have high VOC contents which are known to be effective in the removal of ink. However, such volatile organic compounds have a number of drawbacks (i.e. they are dangerous due to high inflammability and/or health hazards to humans and other animals, and to the environment). Additionally, they can cause the rubber found in printing cylinders, rollers and blankets to swell and subsequently to shrink, harden and crack. Furthermore, the reduction of VOCs relates to increased worker safety, since reduced VOCs lead to less solvent exposure in the workplace.

A solvent, usually a liquid, is a substance that is capable of dissolving other substances and forming a uniform mixture called a solution. The substance dissolved is called the solute and is usually considered to be the component present in the smallest amount.

Successful attempts were made to use solvent compositions based on vegetable oils for the purpose of cleaning printing machines, presses and their components, and many such vegetable products have been tried since then. Generally vegetable oils have high boiling points and are based on a class of zero-VOC solvents.

U.S. Pat. No. 5,104,567 e.g. discloses environmentally acceptable cleaning liquids for the removal of printing inks consisting of 90 to 99% by weight of vegetable oil, in particular soy oil, and 1 to 10% by weight of a surfactant emulsifier.

U.S. Pat. No. 5,340,493 contains a mixture of a base solvent from 20 to 95% by weight of tall oil fatty acid ester combined with organic solvents and/or surfactants. Furthermore, water may be added to the composition for removal or rinsing since the cleaning composition contains a water-active surfactant.

However, the compositions described above have the disadvantage of leaving remarkable amounts of residues consisting mainly of fatty acids or fatty acid esters on the treated surfaces which have to be removed in a second aqueous cleaning step.

WO 2008/1463683 solves this problem by using a composition comprising a relatively high amount of ionic surfactants for emulsifying the non water-soluble components. However, ionic surfactants are known as being harmful to the environment so that their use does not represent a real improvement in terms of environmental safety.

It was the purpose of the present invention to provide environmentally friendly low VOC compositions. These compositions should be useful for example as solvents in printing inks, varnishes and lacquers as well as cleaning compositions, especially for removing water-based, oil-based and radiation-curing printing inks from pressroom equipment, essentially without leaving residues on treated surfaces after removal of the inks, so that cleaning can be performed in a single cleaning step. Furthermore, the compositions of the invention should not affect surfaces with which they come into contact.

This problem is solved by the subject-matter of the claims.

The solubility behavior of an unknown substance often gives us a clue to its identification.

As far as solubility scales are concerned, product literature and technical reports present a bewildering assortment of such systems, for example: Kaouri-Butanol number, solubility grade, aromatic character, aniline cloud point, wax number, heptane number, and Hildebrand solubility parameter, among others.

The compositions of the present invention, apart from offering improved solvent properties and less environmental impact, facilitate less material interaction during cleaning and printing operations, especially with regard to elastomer materials. The compositions of this invention preferably have swelling parameters in the range of from 3.0% Δm to 10.0% Δm, more preferably of 3.0% Δm to 6.0% Δm.

The swelling parameters are measured in accordance with DIN 53521 using test bodies (in German: “Prüfklappen”) with a diameter of 36.6 mm and a thickness of 6 mm; the material is then stored with 100 ml of the compositions at 23° C. for 24 hours. The weight difference of the test bodies before and after exhibition to the compositions is measured and indicated as Δm.

It is apparent that the properties of the compositions of this invention are useful in printing inks, varnishes and lacquers as well as in cleaning compositions. Therefore, the compositions of the present invention can be cleaning compositions, printing ink compositions, varnishes or lacquers. Of course, depending on the kind of composition, the compositions of the present invention may further comprise one or more pigments, one or more resins and further optional additives, depending on the intended use.

In particular, the above-described problem is solved by compositions comprising a solvent system, wherein the compositions are formulated such that the solvent system has Hansen Solubility Parameters as follows:
a.) a dispersion force component in the range of from 8 to 19, preferably of 14 to 18 and more preferably from 16 to 17.5,
b.) a hydrogen bonding component in the range of from 2 to 19, preferably of 2 to 11 and more preferably from 4 to 10.6,
c.) a polar component in the range of from 2.5 to 13, preferably of from 4.0 to 11 and more preferably from 4.0 to 7.

In this description the expression “solvent system” may refer to a single solvent or to a mixture of two or more solvents. Preferably, it refers to a mixture of at least one main solvent and at least one auxiliary solvent. In the present invention the compositions are such that the solvent has the above-mentioned Hansen Solubility Parameters, i.e. by choosing the correct compounds and the correct proportions of compounds, a solvent system is obtained that has the required Hansen Solubility Parameters. The Hansen Solubility Parameters can be achieved by combining the right components to form the solvent system of this invention.

The Hansen system divides the total Hildebrand value for a substance into three parts: a dispersion force component, a hydrogen bonding component and a polar component. The three Hansen parameters are additive like vectors. Solvents can easily be blended to exhibit selective solubility behavior, or to control such properties as evaporation rate and solution viscosity. As such, solubility properties are a net result of intermolecular attractions. A mixture of solvents with the same solubility parameters like a single solvent will exhibit the same solubility behavior. The skilled person can easily find the Hansen Solubility Parameter of known solvents in public databases like Hansen, Charles (2007), “Hansen Solubility Parameters: A user's handbook”, Second Edition (Boca Raton, Fla.: CRC Press), Barton, AFM (1991). “Handbook of Solubility Parameters and Other Cohesion Parameters”, 2^{nd} edition. CRC Press and HSPIP software (Charles M. Hansen; “Hansen Solubility Parameter”, 3 ed).

In the present invention the solubility parameter of the solvent system is determined by calculating the volume-wise contribution of the solubility parameters of the individual components of the mixture. This leads to a reduction in the amount of organic solvent needed for a formula to have satisfactory cleaning properties and solvent properties, which is advantageous in terms of safety and environmental protection.

If the above-mentioned Hansen Solubility Parameters are chosen, compositions can be obtained that combine superior properties with the required low VOC content. Heretofore, the skilled artisan was without any guidance regarding the system based upon which he should choose the right solvent systems for respective compositions. Often the solvent would be too volatile and thus fulfill the definition of VOC; in other cases the solvent would have bad solvent properties because of too high polarities. Naturally, those substances that have lower vapor pressures than the VOCs do not evaporate very easily so that they leave residues on surfaces, which require additional cleaning steps. These drawbacks are avoided by choosing the components of the solvent system based on their Hansen Solubility Parameters. Obviously, cleaning compositions as well as printing inks, varnishes and lacquers require their solvents to have similar properties at least in the two aspects that the compositions should have low VOC content and that both compositions should have solvent systems with good solvent properties. Of course, these properties can also be useful in further applications. The present invention therefore covers all those compositions comprising a solvent system according to the present invention that require low VOC content and good solvent properties.

If the compositions of this invention are used as cleaning compositions, they perform their function by dissolving color components, in particular by dissolving contaminations (fats, oil or inks) on a molecular basis and/or by base hydrolysis of color components, and can then be removed, leaving the surface substantially free of contaminants. It is preferred that the compositions are cleaning compositions. In most preferred embodiments the compositions include water-based and solvent cleaner properties (2 in 1 system). Accordingly, the inventive compositions are preferably used in a one-step cleaning process; and the cleaning compositions are preferably single phase cleaning compositions.

In this aspect the cleaning compositions of the present invention differ significantly from other—mostly two-step—cleaning compositions described in the art, where printing surfaces are usually cleaned by an organic solvent composition in a first step while in a second step the residues of the first cleaning step have to be removed by additional washing of the surfaces with water.

In order to achieve most advantageous solvent properties the solvent system and other components of the compositions should preferably be chosen based on the further parameters described below.

Throughout this description the term “% by weight” should be understood as the relative proportion of the respective compound based on the total weight of the compositions unless otherwise indicated.

The total content of solvent system in the compositions is preferably up to 99% by weight, more preferably up to 92% by weight. In a further preferred embodiment the content of solvent system in the compositions is up to 60% by weight, preferably up to 40% by weight based on the total amount of the compositions.

On the other hand, the amount of said solvent system in the compositions are preferably not less than 10% by weight, preferably not less than 5% by weight.

In a most preferred embodiment of the invention the total content of solvent system is in the range of 10 to 40% by weight based on the total amount of the compositions.

In order to achieve the inventive effects it is essential that the compositions comprise the solvent system, especially in the amounts mentioned above. The rest of the compositions can be composed of many different further compounds that include for example water, other solvents, surfactants, pigments, resins and other additives based on the intended use of the compositions. These substances further improve the advantageous properties of the compositions. A further improvement of the compositions that comprise the solvent system according to this invention is water-miscibility, which allows a cleaning composition based on the inventive composition to act as a one-step cleaner. “Water-miscibility” preferably means that the solvent system is forms a single phase system with water, i.e. it does not form an emulsion or suspension.

The present invention is particularly suitable for cleaning pressroom equipment. A preferred application of the compositions of this invention is the removal of water-based, oil-based and radiation-curing printing inks from ink reservoirs, tubes, pumps, printing cylinders, blankets, anilox rollers, printing rollers, sleeves, surfaces of printing presses and floors. These surfaces can be those encountered in any type of impact printing processes (e.g. lithographic, offset, waterless offset printing, high pressure, flexo, screen printing, letter pressetc.) as well as any type of non-impact printing processes (e.g. electrophotography, ionography, magnetography, ink jet, thermography, etc.). A most preferred field of application of the inventive compositions is cleaning of equipment used in narrow web, particular in label printing operations.

However, this invention may be applied for cleaning any surface from which ink, paint, dirt or other contaminants (dust, particular paper dust, grease, oil, adhesive particles, particular glue etc.) are to be removed. This also includes cleaning of lab equipment or even non-industrial application such as office or home use.

Application and use of the inventive compositions is not limited to manual applications, but could also be applied in conjunction with automatic washing systems. Technical methods of applying the compositions in cleaning processes are well known in the art.

In order to exert the inventive effects, the compositions should preferably have the following characteristics:

The specific gravity of the compositions does preferably not exceed a value of 1.100 g/ml, more preferably 1.010 g/ml and most preferably a value of 1.005 g/ml.

The compositions have low viscosities, which do not exceed the value of 80 s, preferably 65 s and most preferably a value of 58 s of drainage time in the DIN 53211 method (method: DIN beaker 2, DIN53211, runout injection 2 mm).

Preferably, the compositions are miscible, more preferably well miscible with water and preferably all kinds of organic solvents, especially ethers, esters, carboxylic acids, alcohols and so on. All the components of the compositions preferably dissolve homogeneously in water, forming a solution.

Preferably, the compositions are thermodynamically stable in the temperature range of from −20° C. to 80° C., preferably of from 5° C. to 30° C., non-corrosive, low odor, high flashpoint transparent, very fluid, and non-streaking.

In a preferred embodiment of the invention the compositions are directly used as cleaning agents, in other preferred embodiments the compositions are diluted prior to use. The grade of dilution depends on the kind and the grade of contamination of the surfaces to be cleaned with the compositions. Preferred dilutions comprise the composition and a diluent, wherein the amount of diluent is from 0% to 300% (V/V) relative to the amount of composition. In further preferred embodiments, the amount of diluent is from 50% to 300% (V/V) or alternatively from 0% to 100% (V/V) relative to the amount of composition. The present invention also covers the dilution of the compositions with diluent, wherein the preferred diluent is water. Further, the present invention also covers a method of manufacturing the dilution by the step of adding a diluent to the composition and, preferably, stirring the resulting solution to obtain a homogeneous mixture.

The solvents in the compositions have the basic function of dissolving the organic parts of residues on rollers and blankets or other surfaces; or if the compositions are used in printing inks, they serve the purpose of dissolving the resins and other soluble components in the ink. The solvent system softens the ink/paper residues on roller surfaces and allows cleaning compositions to remove the organic raw materials more easily. The compositions have a lubricating effect, which is useful in many applications and also enhances the dirt transport in cleaning compositions.

The compositions of this invention preferably have an amount of volatile organic compounds (VOCs) of not more than 10% by weight, preferably of less than 8% by weight and more preferably of not more than 5% by weight and most preferably not more than 2% by weight based on the total amount of the composition. In a preferred embodiment of the invention the compositions are essentially free of VOCs, wherein “essentially free” preferably means that the compositions have VOC contents of less than 0.1% by weight or even less than 0.01% by weight.

The solvent system in the present compositions preferably comprises a main solvent which is selected based on the Hansen Theory for solubility parameter (see literature: Hansen, Charles (2007), “Hansen Solubility Parameters: A user's handbook”, Second Edition (Boca Raton, Fla.: CRC Press), Barton, AFM (1991). “Handbook of Solubility Parameters and Other Cohesion Parameters”, 2^{nd} edition. CRC Press, Martina Levin, Per Redelius. “Determinastion of Three-Dimensional Solubility Parameters and Solubility Spheres for Naphtalenic Mineral Oils”, Ernergy&Full 2008, 22, 3395-3401.)

Preferably, the main solvent is an organic solvent. In preferred embodiments the main solvent has a hydroxyl group. It is preferably present in amounts of from 5 to 80% by weight relative to the composition and more preferred in an amount of up to 50% by weight and most preferably up to 25% by weight. In preferred embodiments, the main solvent is the only component of the solvent system. In further preferred embodiments, the main solvent constitutes at least 20% by weight of the solvent system and further preferred at least 82% by weight. Preferably, the content of main solvent in the solvent system will exceed the content of auxiliary solvent.

In a preferred embodiment the main solvent is an aliphatic glycol ether, especially with the general formula (I):

R¹—O-(M-O)ₙ—R² (I)

wherein R¹ and R² can independently be selected from hydrogen and alkyl with a carbon chain length of C₁-C₅, wherein the alkyl can independently be branched or unbranched and preferably unbranched. In preferred embodiments, one of R¹ and R² is hydrogen. In further preferred embodiments, one of R¹ and R² is hydrogen and the other is alkyl.

M is preferably alkylene with a preferred carbon chain length of C₁ to C₅, preferably C₂ or C₃. In preferred embodiments M is an ethylene group. In other preferred embodiments M is an n-ethylene (or preferably n-propylene) group. In other preferred embodiments M is an iso-propylene group.

In the general formula “n” indicates the number of monomers of which the glycol ether is composed. n is preferably at least 1. Preferably, n is up to and including 5, further preferred up to and including 4 and most preferred up to and including 3. In a preferred embodiment n is 1. In alternative embodiments n is 2 and in other embodiments n is 3.

In a preferred embodiment R¹ is C₂ to C₅ alkyl, preferably C₄ alkyl. In preferred embodiments R² is hydrogen.

In another preferred embodiment R¹ is hydrogen and R² is methyl. In another preferred embodiment R¹ and R² are both hydrogen.

In another preferred embodiment R¹ and R² are ethyl.

In another preferred embodiment R¹ and R² are both butyl. In an alternative embodiment R¹ and R² are the same and n is at least 5. In these embodiments R¹ and R² are preferably selected from C₁ to C₄ alkyl.

In another preferred embodiment R¹ and R² are both methyl.

In an alternative embodiment R¹ is ethyl and R² is methyl.

In preferred embodiments of the present invention the main solvent selected from the group consisting of 2-butoxy-ethanol, 2-(2-butoxyethoxy)ethanol, 2-[2-(2-butoxyethoxy)ethoxy]ethanol, tripropylene glycol methyl ether, (2-methoxy-methylethoxy)propanol, methoxypropanol.

In other preferred embodiments the main solvent is selected from the group consisting of polyethylene glycol dimethyl ether, polyethylene glycol diethyl ether, polyethylene glycol dibutyl ether.

In other preferred embodiments the main solvent is selected from the group consisting of dipropylene glycol dimethyl ether, diethylene glycol dimethyl ether, diethylene glycol ethylmethyl ether.

In another preferred embodiment the main solvent is triethylene glycol.

The main solvent can also be chosen from the group of the 2-ethylhexyl derivates, especially from the group consisting of 2-ethylhexyl benzoate, 2-ethylhexyl-cocoate, 2-ethylhexyl lactate and n-octyl benzoate.

Other preferred solvents are diesters of adipic acid and of glutaric acid.

The solvent system in the compositions of this invention can comprise one or more of the above-mentioned compounds as main solvent.

The solvent system in the compositions of this invention can preferably comprise at least one further solvent, which is hereinafter referred to as the “auxiliary solvent”. This auxiliary solvent can be used in order to influence the Hansen Solubility Parameter of the solvent system such that the required values can be obtained. The auxiliary solvent can be used to increase solubility of the main solvent in diluents, especially in water. Preferably, the auxiliary solvent is an organic solvent.

Of course, the compositions of the present invention may also comprise further solvents that are not discussed in detail herein. However, in most preferred embodiments, the solvent system in the compositions consists of main solvent and auxiliary solvent.

The auxiliary solvent is preferably selected from the group of the esters, while most preferred esters are esters of the formula (II):

R³—O—CO—R⁴ (II)

wherein R³ is alkyl and R⁴ is alkyl or aryl or aralkyl. Obviously, in formula (II) R³ belongs to the alcohol component and R⁴ belongs to the acid component forming the ester. O—CO-represents the ester linkage.

In preferred embodiments R³ is C₂ to C₁₀ alkyl, branched or unbranched, wherein C₅ to C₁₀ alkyl is preferred. In more preferred embodiments R³ is branched alkyl. Most preferably R³ is a branched C₈ alkyl group.

R⁴ is preferably C₃ to C₁₀ alkyl or aryl or aralkyl. Preferably, R⁴ is unsaturated and has at least 5 and up to 9 carbon atoms. More preferably R⁴ is laurate, benzoate, or cocoate.

The auxiliary solvent can be chosen from the group of the 2-ethylhexyl derivates, especially from the group consisting of 2-ethylhexyl benzoate, 2-ethylhexyl cocoate, 2-ethylhexyl lactate and n-octyl benzoate.

The auxiliary solvent is preferably present in the compositions in an amount of not more than 10% by weight, preferably not more than 5% by weight based on the total amount of the composition. Preferably, the content of the auxiliary solvent is at least 1% by weight and more preferred at least 2% by weight.

The mass ratio of main solvent to auxiliary solvent is preferably from 2:1 to 20:1, more preferably from 4:1 to 12:1 and most preferably from 5:1 to 8:1.

Preferred embodiments of the compositions also comprise water.

The amount of water in the compositions is preferably not less than 25% by weight, more preferred not less than 50% by weight. The amount of water does preferably not exceed the value of 90% by weight, preferably 85% by weight and most preferably 75% by weight.

In the compositions there is a preferred mass ratio between the amount of water and the amount of the solvent system.

The mass ratio of water relative to the solvent system is preferably between 0.5:1 and 13:1, more preferably from 1.5:1 to 8:1 and most preferably from 2:1 to 5:1. The composition preferably has an alkaline pH, especially ranging from 8.0 to 13.0. The pH is preferably adjusted by addition of one or more inorganic or organic bases or mixtures thereof. In preferred embodiments the content of bases does not exceed the value of 5% by weight, preferably 2% by weight, based on the total amount of the cleaning composition. Preferably, the amount of bases is at least 0.2% by weight.

Preferred organic bases are organic amines, preferably belonging to the group consisting of 2-amino-2-methylpropanol, trisodium salt of methylglycinediacetic, monoethanol amine, diethanol amine and triethanol amine.

Preferred inorganic bases are caustic soda or potassium hydroxide.

Acids and bases can play an important role in stabilizing the pH at a given value while reducing the effect of external factors that can slowly pollute the composition and influence its pH value.

Oils and esters that are usually used in printing ink formulations are hydrolyzed in form of a nucleophilic substitution at high pH and then can more easily be removed by the aqueous cleaner from the roller and blanket surfaces since the reaction products are more water soluble. Therefore, the compositions of this invention are preferably alkaline. Alkaline properties are useful in cleaning compositions because they can induce ester hydrolysis more effectively than acid compositions.

Thus the addition of bases can increase the dissolving efficiency. At presence of alkaline additives in the composition the efficiency of the cleaning results from the combination of two different technical approaches that are acting synergistically:

On the one hand, the alkaline component with high pH hydrolyzes oils and esters in the presence of water to dissolve most resins commonly found in printing inks. On the other hand, the compositions comprise one or more solvents (such as main and auxiliary solvents), preferably with high solvency power and miscibility in water and in organic solvents, which can dissolve further residues that cannot be removed by aqueous alkaline solutions. The aqueous component in the inventive compositions facilitates a cleaning process that does not require subsequent washing steps with water.

Additionally, but only optionally the compositions can also comprise additives like surfactants, corrosion inhibitors, chelating agents, flocculants and/or defoamers.

In a preferred embodiment of the invention the composition is essentially free of those additives without losing its effectiveness.

Preferably, the compositions are essentially free of any halides, especially halo-carbon-compounds, and thus the ODP (ozone depletion potential) of the system is preferably 0.

When present in the compositions, surfactants also can have a certain solvent ability that further dissolves various compounds and thus enhances the solvent properties.

It is an advantage of the compositions of the present invention that they do not comprise excessive amounts of surfactants, especially ionic surfactants. This is an advantage because these compounds have bad reputation as they are often harmful to the environment and harmful to human health.

In some embodiments of the invention however the compositions comprise at least one surfactant. Non-ionic surfactants are preferred. Nevertheless, the overall amount of surfactants in the compositions does not exceed a value of 15% by weight, preferably 10% by weight, based on the total amount of the composition. In the compositions that comprise surfactants, they are present in a proportion of at least 0.5% by weight; more preferred at least 1.5% by weight.

The surfactants can be ethers, thioethers, hydroxyl thioethers, esters but also other compounds like alkyl pyrrolidones.

Preferred surfactants are alcohol ethoxylates, especially fatty alcohol ethoxylates, most preferably having a carbon chain length of C₁₀-C₁₃, while ethoxylates with 3 to 10 ethoxylate groups are most preferred. Other surfactants that can be used in the present invention are alkyl polyglucosides or propylene oxide/ethylene oxide block polymers.

In preferred embodiments, nonionic surfactants are present in the compositions in an amount of not more than 6% by weight, preferably 3 to 6% by weight.

In preferred embodiments, ionic surfactants are present in the compositions in an amount of not more than 3% by weight, preferably 0.8% by weight. In preferred embodiments, the compositions are essentially free of ionic surfactants.

In most preferred embodiments the compositions comprise 2 to 10% by weight of a surfactant mixture of nonionic surfactants consisting of:
a.) reaction products of ethanol with epichlorohydrin and 2-mercaptoethanol,
b.) C₁₂₋₂₂ alcohol ethoxylates with a degree of alkoxylation of 3 to 15 and,
c.) reaction product of acetylene with C₁₀₋₁₅ oxoalcohol alkoxylates with a degree of alkoxylation of 5 to 15.

In another preferred embodiment of the invention acetylenic compounds are used as non-ionic surfactants, 2,4,7,9-Tetramethyldec-5-yne-4,7-diol (TMDD) and its ethoxylates (1.3 to 30 moles added per mole of TMDD) being most preferred compounds.

Preferred surfactants belong to the group of esters, especially aliphatic esters of di-carboxylic acids.

The salts diluted in the compositions can induce the corrosion of metallic parts of, for example, printing presses, if misting occurs. The fact that the compositions are preferably aqueous and alkaline tends to worsen the corrosion. Some metal specific corrosion inhibitors can be introduced in the compositions to limit the corrosion.

The compositions optionally comprise corrosion inhibitors in an amount of up to 2% by weight, preferably in an amount between 0.05 and 0.5% by weight based on the total amount of the composition. Preferably, but not exclusively, the corrosion inhibitors are members of the group consisting of 4-((2-ethylhexyl)-amino)-4-oxoisocrotonic acid mixed with 2,2,2-nitrilotris(ethanol) in a molar ratio of 1:1; [[(phosphonomethyl)imino]bis[(ethylenenitrilo)bis(methylene)]]tetrakisphosphonic acid sodium salt; benzotriazole; tolyltriazole; octyl phosphonate.

The aim of using chelates is to achieve two effects. Some chelates based on phosphonates and polyacrylic polymers can be used as scale inhibitors since the composition may slowly accumulate calcium carbonate from the rollers and blankets coming from the ink and paper. Chelates also complex magnesium and calcium precipitates that accumulate on the rollers that organic solvents and surfactants cannot remove from the surface. They are then more easily transferred from the surfaces to be cleaned by the preferably aqueous medium of the composition.

The compositions optionally comprise chelating agents in an amount of up to 2% by weight, preferably in an amount of not more than 0.5% by weight based on the total amount of the composition.

Preferably, but not exclusively the chelating agents used in the present invention are members of the group consisting of amine based chelates, phosphonate based chelates and chelating polymers or co-polymers of carboxylic acids.

Preferred chelating agents are alanine, N,N-bis(carboxymethyl)-tri sodium salt; ethylene diamine tetraacetate (EDTA) and its sodium salts; nitrilotriacetic acid (NTA); diethylene triamine pentaacetic acid (DTPA); diaminoethane tetraacetic acid.

Other preferred chelating agents are diethylene triamine penta(methylene phosphonic acid), sodium salt; 1-hydroxyethylidene-1,1-diphosphonic acid; nitrilotrimethylenetris(phosphonic acid); 2-phosphonobutane-1,2,4-tricarboxylic acid.

Other preferred chelating agents from the group of the polymers or co-polymers of carboxylic acids are polyacrylic acid, sodium salt; modified polyacrylic acid, sodium salt; modified polycarboxylate, sodium salt; maleic acid/olefin co-polymerisation product, sodium salt; maleic acid/acrylic acid co-polymerisation product, sodium salt.

Another preferred chelating agent is polyvinyl pyrrolidone.

The composition optionally comprises at least one inorganic builder, preferably selected from the group consisting of zeolite, soda ash, and silicates.

Preferably, the inorganic builder is present in the composition in an amount of not more than 2% by weight, most preferably in an amount of not more than 0.5% by weight based on the total amount of the composition.

The composition optionally comprises at least one hydrotrope in an amount of not more than 10% by weight, preferably in an amount of not more than 5% by weight based on the total amount of the composition.

The amount used mainly depends how much hydrotrope is needed to stabilize the compositions at temperatures in a range between 0° C. and 50° C. so that it remains homogeneous and to what degree the hydrotrope enhances the composition's solvency power.

Hydrotropes and emulgators in these compositions have several properties. They ensure phase stability over time, and stability over a wide range of temperatures encountered during production, storage, transport and utilization. They also further improve the dissolution of raw materials with poor water solubility due to their ability to emulsify hydrophobic parts in aqueous media.

Preferably, but not exclusively the hydrotropes are selected from the group consisting of 2-ethylhexyl sulfate, sodium salt; alkylphenyl sulfonate, preferably cumenesulfonate, sodium salt; capryloamphodiproprionate, sodium salt; iminodipropionate, sodium salt and its derivates; naphthalene sulfonic acid and its derivates.

The compositions optionally comprise at least one flocculant in an amount of preferably not more than 1.0%, preferably not more than 0.2% by weight, preferably in an amount of not more than 0.025% by weight based on the total amount of the composition.

Preferably, the flocculants are cationic or anionic polyacrylamides.

Depending on the nature and extent of dirt accumulated in the compositions, especially if they should be recycled and used several times, it is possible to keep the contaminant level in the compositions at an acceptable level by using flocculants. The particles in suspension may aggregate with the proper flocculant and settle, making it easier to be removed from the compositions through filtration.

The compositions optionally comprise at least one defoamer in an amount of not more than 0.3% by weight, preferably in an amount of not more than 0.15% by weight based on the total amount of the composition.

Preferably, the defoamers are selected from the group consisting of silicone defoamers, polysiloxanes, polyethersiloxanes.

In a most preferred embodiment the defoamer is 2,5,8,11-tetramethyldodec-6-yne-5,8-diol.

Defoamers are sometimes necessary in compositions to control the foaming property of hydrotropes, polymers and surfactants. Indeed superabundant foam can sometimes lead to filming issues of the compositions.

The present invention also refers to the use of the compositions for cleaning surfaces, especially surfaces that are contaminated with ink residues. These surfaces are for example those encountered in narrow web printing presses.

Furthermore, the present invention refers to the use of the compositions in printing inks.

The invention also refers to a method of cleaning a surface comprising
optionally diluting a composition according to this invention with a diluent to form a dilution of the composition, and
applying to a surface the composition.

The compositions can be applied to any surface by usual means like for example a piece of cloth, or can be used in conventional cleaning machines.

Furthermore, the present invention refers to a process of preparing a printing ink comprising
blending a composition of the present invention with printing ink additives.

The printing ink additives will usually comprise resins, pigments or dyes as well as further typical ink ingredients.

The solvent system described as part of the compositions above is an important aspect of this invention. As discussed in detail above: it is useful in a variety of applications because of its low VOC content, very good solvent properties and water miscibility. Therefore, the solvent system can be used in any application where these properties are relevant, preferably in cleaning compositions of any kind, including household cleaners, as well as printing inks, varnishes, adhesives and lacquers. The use preferably includes that the solvent system is used, especially blended, with water.

### EXAMPLES

The following examples illustrate specific aspects of the present invention and are not intended to limit the scope thereof in any aspect and should not be so construed. The following chart gives an overview of cleaning compositions of this invention.

| Component | E1 | E2 | E3 | E4 | E5 | E6 | E7 |
|---|---|---|---|---|---|---|---|
| Water | 70.7 | 30 | 71.75 | 58.1 | 80.7 | 85 | 0 |
| Glycol ethers )¹ | 19.975 | 47 | 20 | 24.96 | 7 | — | 83 |
| Octyl benzoate )² | — | — | — | 4 | — | — | 8 |
| Glycol diethers )¹ | — | 20 | — | — | — | — | — |
| C₁₀ -C₁₃ fatty alcohol ethoxylates | 5 | 3 | 5 | 3.6 | 5 | 7.2 | 3 |
| Hydroxythioether | 1 | — | 1 | 0.8 | — | — | 0.5 |
| Alkylpyrrolidone | — | — | — | — | 0.5 | — | — |
| Organic amines | 1.8 | — | 1.8 | 1.4 | 2 | 1.5 | |
| C₆ alkyl sulfonate Na-salt | — | — | — | 0.7 | 1.2 | 5 | — |
| EDTA, Na-salt | 0.5 | — | 0.2 | 0.2 | — | — | — |
| Polyacrylic acid, Na-salt | | — | — | — | 2.5 | 1 | — |
| Maleic acid/Olefin co-polymerization | 0.75 | — | — | — | — | — | — |
| product, Na-salt | | | | | | | |
| Organic phosphonic acid, | 0.05 | — | 0.05 | 0.04 | 0.1 | 0.3 | — |
| Diethylenetriamine Penta(methylene | | | | | | | |
| phosphonic acid), Na-salt | | | | | | | |
| Dibasic esters | — | — | — | 6 | 1 | — | 5.3 |
| Corrosion inhibitors | 0.1 | — | 0.1 | 0.1 | — | — | 0.1 |
| Flocculants | 0.025 | — | — | — | — | — | 0.1 |
| Defoamers | 0.1 | — | 0.1 | 0.1 | — | — | 0.1 |
| VOC content | 0% | 0% | 0% | 0% | 0% | 0% | 0% |
| Total | 100.0 | 100.0 | 100.0 | 100.0 | 100.0 | 100.0 | 100.0 |

)¹ These substances represent here the main solvent of the example composition.
)² These substances represent here the auxiliary solvent of the example composition.

1. Composition comprising a solvent system, wherein the composition is formulated such that the solvent system has Hansen Solubility Parameters as follows:
a.) a dispersion force component in the range of from 8 to 19,
b.) a hydrogen bonding component in the range of from 2 to 19,
c.) a polar component in the range of from 2.5 to 13.

2. The composition according to claim 1, wherein the solvent system comprises at least one main solvent.

3. The composition according to claim 1, wherein the solvent system comprises at least one auxiliary solvent.

4. The composition according to claim 2, wherein the main solvent is a glycol ether.

5. The composition according to claim 3, wherein the auxiliary solvent is an ester.

6. The composition according to claim 3, wherein the content of the main solvent exceeds the content of the auxiliary solvent.

7. The composition according to claim 1, wherein the composition comprises volatile organic compounds (VOCs) in an amount less than or equal to 10% by weight based on the total amount of the composition.

8. The composition according to claim 1, wherein the solvent system is present in an amount of up to 92% by weight.

9. The composition according to claim 1, wherein the composition comprises water.

10. The composition according to claim 9, wherein the amount of water in the composition is at least 25% by weight based on the total amount of the composition.

11. The composition according to claim 1, wherein the composition is a solution.

12. The composition according to claim 1, wherein the composition is alkaline.

13. The composition according to claim 2, wherein the composition comprises an alcohol ethoxylate as a surfactant.

14. The composition according to claim 1, wherein the composition is a cleaning composition, a printing ink, a varnish or a lacquer.

15. Method of cleaning a surface comprising
optionally diluting the composition with a diluent to form a dilution of the composition, and
applying the composition of claim 1 to the surface.

16. Use of the composition according to claim 1 for removing printing ink.

17. A solvent system formulated such that it has Hansen Solubility Parameters as follows:
a.) a dispersion force component in the range of from 8 to 19,
b.) a hydrogen bonding component in the range of from 2 to 19,
c.) a polar component in the range of from 2.5 to 13.

18. Use of the solvent system according to claim 17 in cleaning compositions, printing inks, varnishes, adhesives or lacquers.
